(19) United States
(12) Patent Application Publication
(10) Pub. No.: US 2021/0214043 A1
(43) Pub. Date: Jul. 15, 2021

(54) MOTOR UNIT AND ELECTRIC BICYCLE

(71) Applicant: Panasonic Intellectual Property Management Co., Ltd., Osaka (JP)

(72) Inventors: Masato NISHIMORI, Hyogo (JP); Masafumi KAWAKAMI, Nara (JP)

(21) Appl. No.: 17/056,266

(22) PCT Filed: May 8, 2019
(86) PCT No.: PCT/JP2019/018347

§ 371 Date: Nov. 17, 2020

(30) Foreign Application Priority Data
May 23, 2018 (JP) 2018-099157

(51) Int. Cl. B62M 6/55; H02K 11/33; H01R 12/58

(52) U.S. Cl. CPC B62M 6/55; H01R 12/58; H02K 11/33

(57) ABSTRACT

A motor unit includes a substrate, a motor, and at least one conductive member. The substrate has a first surface and a second surface aligned in a thickness direction of the substrate. The motor includes at least one terminal, and in the thickness direction of the substrate, the motor is disposed closer to the second surface than to the first surface. The at least one conductive member is mounted on the first surface. The substrate has at least one through part which extends from the first surface through the second surface and in which the at least one terminal or the at least one conductive member is inserted. The at least one conductive member is at least partially deformable and is connected to the at least one terminal.

### TECHNICAL FIELD

The present disclosure relates to motor units and electric bicycles, and specifically, to an electric bicycle and a motor unit including a substrate and a motor.

### BACKGROUND ART

Patent Literature 1 discloses a conventional motor drive unit. The motor drive unit described in Patent Literature 1 includes a motor and a substrate. The motor is attached to one side surface of a unit case. The substrate is attached to an inner side surface which is one of inner side surfaces of the unit case and which is located on an opposite side of the motor.

The substrate has a mounting surface facing the motor. The motor is connected to the substrate via a harness.

In the motor unit described in Patent Literature 1, since the motor and the substrate are attached on the surfaces opposite to each other with respect to the unit case, downsizing of the motor unit is difficult. In the motor unit described in Patent Literature 1, the mounting surface on which the harness is mounted faces the motor. Therefore, even when the distance between the motor and the substrate is attempted to be reduced, the distance between the substrate and the motor is difficult to be reduced.

### CITATION LIST

### Patent Literature

Patent Literature 1: WO 2014/009995

### SUMMARY OF INVENTION

In view of the foregoing, it is an object of the present disclosure to provide a motor unit and an electric bicycle which are downsized by disposing a substrate close to the motor.

A motor unit of one aspect according to the present disclosure includes a substrate, a motor, and at least one conductive member. The substrate has a first surface and a second surface in a thickness direction of the substrate. The motor includes at least one terminal and is disposed closer to the second surface than to the first surface in the thickness direction. The at least one conductive member is mounted on the first surface. The substrate has at least one through part which extends from the first surface through the second surface and in which the at least one terminal or the at least one conductive member is inserted. The at least one conductive member is at least partially deformable and is connected to the at least one terminal.

An electric bicycle of one aspect according to the present disclosure includes a frame, the motor unit attached to the frame, and a wheel. The wheel is attached to the frame and is configured to be rotated by power output from the motor unit.

### BRIEF DESCRIPTION OF DRAWINGS

FIG. 1 is a side view illustrating an electric bicycle according to one embodiment of the present disclosure;

FIG. 2 is an enlarged view illustrating a motor unit of the electric bicycle;

FIG. 3 is a sectional view along line A-A of FIG. 2;

FIG. 4 is an exploded perspective view illustrating the motor, a first split body, and a substrate.

FIG. 5 is an enlarged perspective view illustrating the substrate;

FIG. 6 is a sectional view illustrating a state where a conductive member is connected to a terminal on the substrate;

FIG. 7 is an enlarged view illustrating portion B of FIG. 2;

FIG. 8 is an enlarged perspective view illustrating a substrate of a motor unit according to a first variation;

FIG. 9 is a sectional view illustrating a state where a terminal and a conductive member of the motor unit according to the first variation are connected to each other;

FIG. 10 is a sectional view illustrating a state where a terminal and a conductive member of the motor unit according to a second variation are connected to each other;

FIG. 11 is a sectional view illustrating a motor unit according to a third variation; and

FIG. 12 is a sectional view illustrating a motor unit according to a fourth variation.

### DESCRIPTION OF EMBODIMENTS

### (1) Embodiment

(1.1) Schema

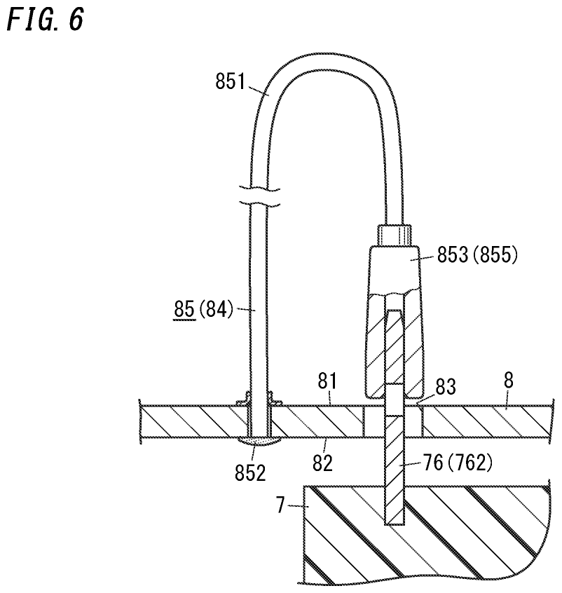

As illustrated in FIG. 6, a motor unit 5 according to the present embodiment includes a substrate 8, at least one conductive member 84, and a motor 7. The substrate 8 has a first surface 81 and a second surface 82 aligned in a thickness direction of the substrate 8. The conductive member 84 is a harness 85 including, for example, an electrical wire 851 and is mounted on the first surface 81 of the substrate 8. The motor 7 is disposed closer to the second surface 82 than to the first surface 81 of the substrate 8. The motor 7 includes a terminal 76 connected to the conductive member 84.

The substrate 8 has at least one through part 83 extending from the first surface 81 through the second surface 82. The terminal 76 or the conductive member 84 is inserted in the through part 83. The conductive member 84 is at least partially deformable.

Thus, according to the motor unit 5 of the present embodiment, the substrate 8 may be disposed close to the motor 7, so that the motor unit 5 is downsized. Moreover, according to the motor unit 5 of the present embodiment, the substrate 8 may be disposed close to the motor 7, but the substrate 8 is not fixed to the terminal 76 of the motor 7 with solder, and the terminal 76 is thus not bound to the substrate 8. Thus, even when the substrate 8 and the motor 7 vibrate, stress caused at the substrate 8 due to force applied by the terminal 76 is reduced.

(1.2) Details

The motor unit 5 of the present embodiment will be described below. As an example of the motor unit 5, a motor unit 5 for use in an electric bicycle 1 will be described below. However, this is one example of the motor unit 5 according to the present disclosure and is not intended to limit applications of the motor unit 5 according to the present disclosure to the electric bicycle 1.

(1.2.1) Electric Bicycle

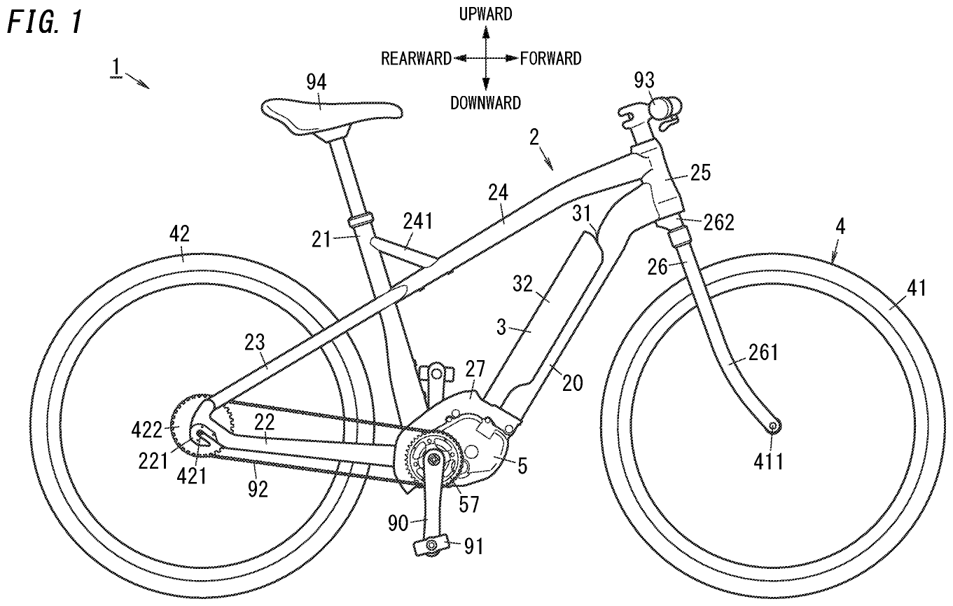

The electric bicycle 1 is a bicycle configured to travel using electrical power. In the present embodiment, the electric bicycle 1 is an electric-assist bicycle in which the motor 7 assists force applied to a pedal by a user (also referred to as “pedal force”), but in the present disclosure, the electric bicycle 1 may be a bicycle that is configured to travel using only the motor 7. In sum, the electric bicycle 1 according to the present disclosure may be an electric-assist bicycle or may be a bicycle configured to travel using only the motor 7. As illustrated in FIG. 1, the electric bicycle 1 includes a frame 2, a plurality of wheels 4, a battery device 3, a handle 93, a saddle 94, crank arms 90, pedals 91, and the motor unit 5. The plurality of wheel 4 includes a front wheel 41 and a rear wheel 42.

Here, in the present disclosure, a direction in which the electric bicycle 1 travels is defined as a “front direction”, and a direction opposite to the front direction is defined as a “rear direction”. Moreover, two directions, namely, the front direction and the rear direction are defined as “forward/rearward directions”, and two directions orthogonal to the forward/rearward directions and extending along a horizontal plane are defined as “rightward/leftward directions”. Here, the horizontal plane is defined based on the electric bicycle 1 traveling on a horizontal surface.

The frame 2 is a frame configured to hold at least, the front wheel 41, the rear wheel 42, and the battery device 3. In the present embodiment, the frame 2 is made of an aluminum alloy containing aluminum as a main component. Note that in the present disclosure, materials for the frame 2 are not limited to the aluminum alloy but may be, for example, carbon or a metal such as iron, chrome molybdenum steel, or high tensile strength steel, titanium.

The frame 2 includes a plurality of tubes. In the present embodiment, the frame 2 includes a down tube 20, a seat tube 21, a plurality of (in the present embodiment, two) chain stays 22, a plurality of (in the present embodiment, two) seat stays 23, a top tube 24, a head tube 25, and a fork 26 as the plurality of tubes. The frame 2 further includes a bottom bracket 27.

As used herein, a “tube” means an elongated hollow member, and the shape of its cross section is not particularly limited. Examples of the cross section of the tube include not only a circular cross section such as a precise circular cross section and oval-shaped cross section (including ellipse-shaped cross section) but also a polygonal cross section such as a square cross section, a rectangular cross section, and a hexagonal cross section.

The bottom bracket 27 is a component to which at least a lower end of the down tube 20 and a front end of the chain stay 22 are connected. In the present embodiment, a lower end of the seat tube 21, in addition to the down tube 20 and the chain stay 22, is connected to the bottom bracket 27. In the present embodiment, the motor unit 5 is attached to the bottom bracket 27.

The down tube 20 is a tube connecting the bottom bracket 27 to the head tube 25. The down tube 20 extends from a front end in the forward/rearward directions of the bottom bracket 27 to the head tube 25, and in a longitudinal direction of the down tube 20, the down tube 20 is tilted upward in the front direction. In the present embodiment, a battery pack 32 is detachably attached to the down tube 20.

The seat tube 21 is a tube that holds the saddle 94. In the present embodiment, the seat tube 21 connects the bottom bracket 27 to the top tube 24. In the present embodiment, the seat tube 21 extends from an upper end of the bottom bracket 27 to a level higher than the top tube 24, and in a longitudinal direction of the seat tube 21, the seat tube 21 is tilted upward in the rear direction. The seat tube 21 holds the saddle 94 such that the saddle 94 is movable along the longitudinal direction of the seat tube 21.

The plurality of chain stays 22 are tubes that connect the bottom bracket 27 to the seat stays 23. Each chain stay 22 extends from a rear end of the bottom bracket 27 to a rear end of a corresponding one of the seat stays 23. In the present embodiment, two chain stays 22 are provided to be apart from each other in the rightward/leftward directions, and the rear wheel 42 is disposed between the two chain stays 22. The rear end of the chain stay 22 has a bearing 221 to which a shaft (a rear wheel shaft 421) of the rear wheel 42 is to be attached. The rear wheel 42 is rotatably attached to the bearing 221.

The plurality of seat stays 23 are tubes connecting an upper end of the seat tube 21 to the chain stays 22. Each seat stay 23 extends from the upper end of the seat tube 21 to a rear end of the chain stay 22, and each seat stay 32 longitudinally tilted downward in the rear direction. The “upper end of the seat tube 21” mentioned herein means a portion having a certain region located to have a certain dimension extending downward from an upper tip end of the seat tube 21 along the longitudinal direction of the seat tube 21. In the present embodiment, two seat stays 23 are provided to be apart from each other in the rightward/leftward directions and are connected to the two chain stays 22 on a one-to-one basis.

The top tube 24 is a tube that connects the head tube 25 to the seat tube 21. Specifically, the top tube 24 connects the head tube 25 to the upper end of the seat tube 21. A rear end in a longitudinal direction of the top tube 24 is connected to the upper end of the seat tube 21. The top tube 24 extends from the upper end of the seat tube 21 to the head tube 25, and in the longitudinal direction of the top tube 24, the top tube 24 is tilted upward in the front direction. In the present embodiment, the frame 2 includes a reinforcement tube 241 that connects the top tube 24 to the seat tube 21.

The head tube 25 is a tube to which a front end of the top tube 24 and a front end of the down tube 20 are connected. The head tube 25 supports the fork 26 and the handle 93 rotatably about a central axis of the head tube 25.

The fork 26 is a tube to which the front wheel 41 is to be attached. The front wheel 41 is attached to the fork 26 rotatably about a shaft (a front wheel shaft 411) of the front wheel 41. The fork 26 includes a pair of legs 261 that support the front wheel shaft 411 and a steering column 262 that extends upward from an upper end of the legs 261 along the central axis of the head tube 25. The fork 26 is attached to the head tube 25 by fitting the steering column 262 in the head tube 25. The handle 93 is attached to an upper end of the steering column 262. Thus, when the handle 93 rotates about the central axis of the head tube 25, the fork 26 rotates about the central axis of the head tube 25, and the front wheel 41 rotates about the central axis of the head tube 25.

The front wheel 41 is a front wheel 4 of the two wheels 4 aligned in the forward/rearward directions. In the present embodiment, the front wheel 41 is supported by the fork 26 rotatably about the front wheel shaft 411. A longitudinal direction of the front wheel shaft 411 is parallel to the rightward/leftward directions. Here, the longitudinal direction of the front wheel shaft 411 is parallel to the rightward/leftward directions in a state where the electric bicycle 1 travels in the front direction. In the present embodiment, the front wheel 41 is a wheel 4 to which power is not transmitted from the motor unit 5.

The rear wheel 42 is a rear wheel 4 of the two wheels 4 aligned in the forward/rearward directions. In the present embodiment, the rear wheel 42 is supported by the two chain stays 22 rotatably about the rear wheel shaft 421. A longitudinal direction of the rear wheel shaft 421 is parallel to the rightward/leftward directions. In the present embodiment, the rear wheel 42 includes a rear sprocket 422 (here, a cassette sprocket) and is coupled to a drive sprocket 57 of the motor unit 5 via a power transmitter 92 (here, a chain). Thus, power of the motor unit 5 is transmitted to the rear wheel 42.

The battery device 3 is a device for supplying electric power to the motor unit 5. However, in the present disclosure, the battery device 3 may be configured to supply electric power to an ON/OFF operation section of the motor 7, the headlight, or the like in addition to the motor unit 5. The battery device 3 includes a battery pack 32 as a secondary battery for accumulating electrical energy and a battery applied part 31 via which the battery pack 32 is electrically connected to the motor 7.

(1.2.2) Motor Unit

The motor unit 5 is a device configured to generate electrical power in the electric bicycle 1. The power generated by the motor unit 5 is transmitted via the power transmitter 92 to the wheel 42. When the motor unit 5 receives pedal force from the pedals 91, the motor unit 5 generates a drive assist output. Note that the “drive assist output” mentioned in the present disclosure means force that supplements the pedal force by using the motor 7. In the present embodiment, when the motor unit 5 receives the pedal force from the pedals 91 and the crank arms 90, the motor unit 5 detects an input value of the pedal force (here, the rotation speed and a torque of an input shaft 54), and based on the input value, the motor unit 5 outputs the drive assist output to the power transmitter 92.

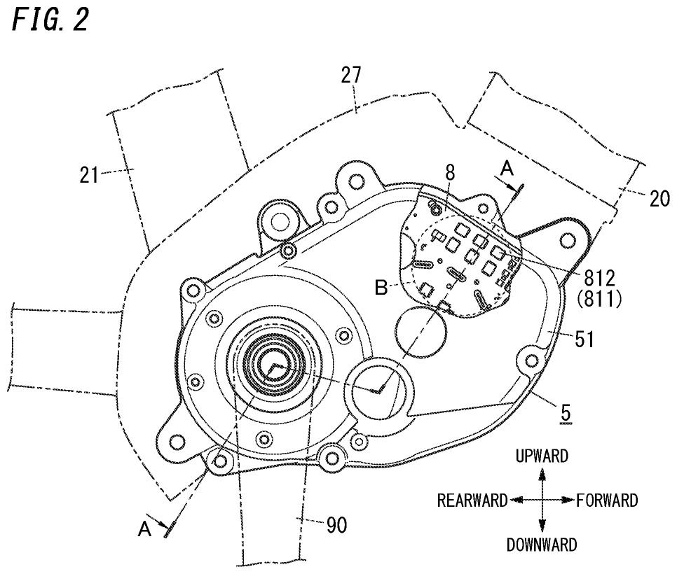

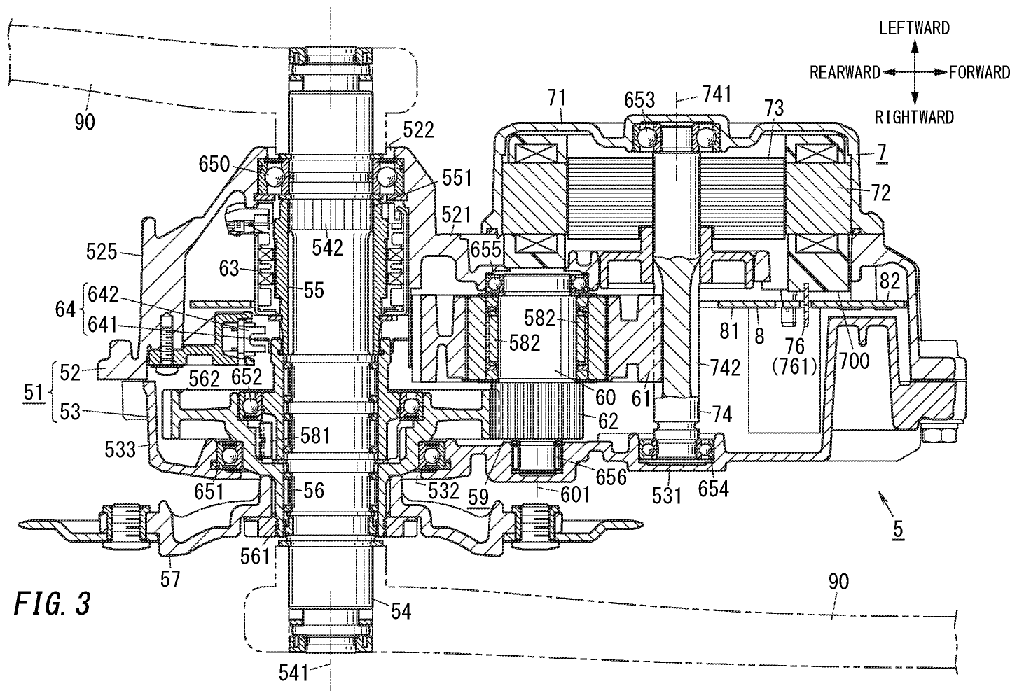

Here, FIG. 2 is an enlarged view of the motor unit 5. In FIG. 2, the unit case 51 is partially cut out. FIG. 3 is a sectional view along line A-A of FIG. 2. As illustrated in FIG. 3, the motor unit 5 includes a unit case 51, the input shaft 54, an inputter 55, an outputter 56, a drive sprocket 57, one-way clutches 581 and 582, a deceleration mechanism 59, the motor 7, and the substrate 8.

The unit case 51 accommodates apparatuses of the motor unit 5. In the present embodiment, the unit case 51 accommodates the input shaft 54, the inputter 55, the outputter 56, the one-way clutches 581 and 582, the deceleration mechanism 59, and the like. In the present embodiment, the unit case 51 is made of an aluminum alloy, but in the present disclosure, the unit case 51 may be made of stainless steel, steel, carbon, a synthetic resin, or the like. In the present embodiment, the unit case 51 is formed by die casting. In the present embodiment, the unit case 51 includes a first split body 52 and a second split body 53.

The first split body 52 has a bottomed cylindrical shape having an opening surface facing in one direction (here, the right direction). The first split body 52 includes a first side wall 521 and a first peripheral wall 525. The first side wall 521 is located on an opposite side (here on the left side) from the opening surface in the rightward/leftward directions. The first peripheral wall 525 protrudes in the one direction (the right direction) from a peripheral edge of the first side wall 521. In the present embodiment, the first side wall 521 is integral with the first peripheral wall 525.

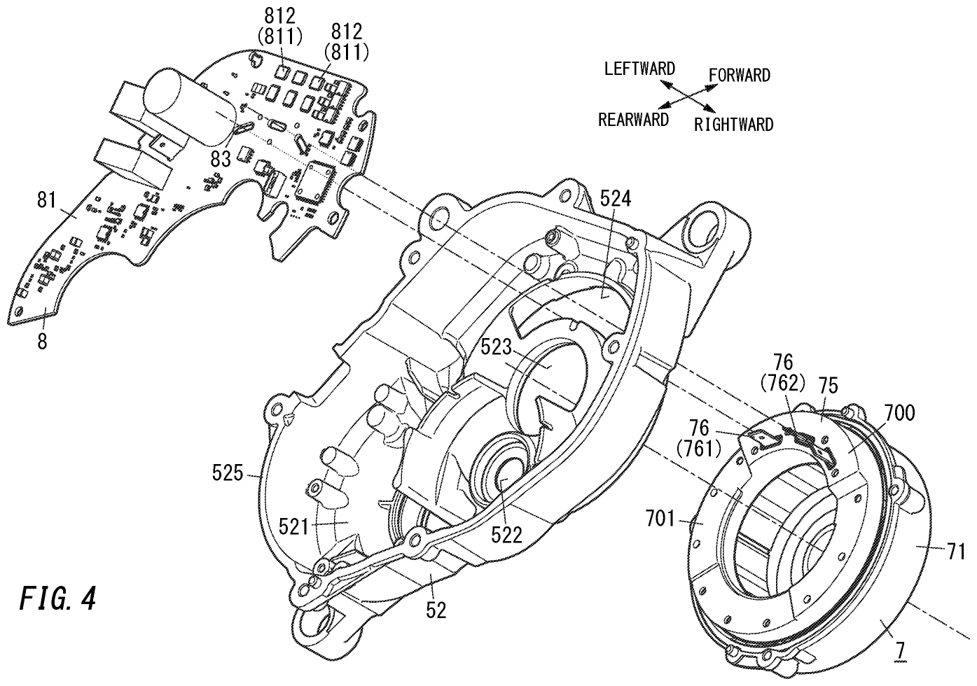

The first side wall 521 has a first through hole 522, a motor through hole 523 (see FIG. 4), and a terminal hole 524 (see FIG. 4). The input shaft 54 is to be inserted into the first through hole 522. An output shaft 74 of the motor 7 is to be inserted into the motor through hole 523. The terminal 76 of the motor 7 is to be inserted into the terminal hole 524. The motor 7 is attached to an outer surface of the first side wall 521 (outer side surface of the motor unit 5) via a fixation member. That is, the motor 7 is attached to the unit case 51 in a state where the motor 7 is disposed along an outer surface of the unit case 51. When the motor 7 is attached to the first side wall 521, the output shaft 74 of the motor 7 is inserted in the motor through hole 523, and the terminal 76 of the motor 7 is inserted in the terminal hole 524.

The second split body 53 has a bottomed cylindrical shape having an opening surface facing in a direction (here, the left direction) opposite to the one direction. The second split body 53 includes a second side wall 531 and a second peripheral wall 533. The second side wall 531 is located on an opposite side (here on the right side) from the opening surface in the rightward/leftward directions. The second peripheral wall 533 protrudes in one direction (the left direction) from a peripheral edge of the second side wall 531. In the present embodiment, the second side wall 531 is integral with the second peripheral wall 533. The second side wall 531 has a second through hole 532 concentric with the first through hole 522 in the rightward/leftward directions.

In the unit case 51, an end surface of the first peripheral wall 525 and an end surface of the second peripheral wall 533 are in contact with each other, and the opening surface of the first split body 52 and the opening surface of the second split body 53 are joined together. In this state, the first peripheral wall 525 is coupled to the second peripheral wall 533 via a fixation member. Thus, the first split body 52 and the second split body 53 are fixed to each other. With respect to the unit case 51, the input shaft 54 is inserted into the second through hole 532 and the first through hole 522. That is to say, the input shaft 54 extends through the unit case 51 in the rightward/leftward directions.

The input shaft 54 is a shaft body which receives pedal force from the crank arms 90. In the present embodiment, the input shaft 54 is supported by a bearing 650 and a bearing 651. The bearing 650 is attached to the first split body 52 to be concentric with the first through hole 522. The bearing 651 is attached to the second split body 53 to be concentric with the second through hole 532. Thus, the input shaft 54 is rotatable about an axis 541 extending to the unit case 51 in the rightward/leftward directions.

Here, as used herein, the “axis” means a certain straight line as the center of the rotation movement of an object. In the present embodiment, the axis 541 (rotation axis) of the input shaft 54 is realized by a central axis of the input shaft 54 rotatably supported by the bearing 650 attached to the first split body 52 and the bearing 651 attached to the second split body 53. The “bearing” according to the present embodiment is a ball bearing, but in the present disclosure, the bearing may be a rolling bearing, a sliding bearing, a fluid bearing, or the like.

The input shaft 54 has both ends to which the respective crank arms 90 are attached. When the input shaft 54 receives pedal force about the axis 541 from the crank arms 90, the input shaft 54 rotates about the axis 541. The inputter 55 is attached to the input shaft 54.

The inputter 55 is a member for transmitting rotative power of the input shaft 54 to the outputter 56. The inputter 55 and the input shaft 54 are coaxially provided, and the inputter 55 is attached to an outer peripheral surface of the input shaft 54. The inputter 55 has a cylindrical shape having a central axis parallel to the rightward/leftward directions. At least part of an inner peripheral surface of the inputter 55 in the center axial direction (here, in the rightward/leftward directions) has a first connection section 551. On the other hand, part of the input shaft 54 in a longitudinal direction of the input shaft 54 has a second connection section 542 to be coupled to the first connection section 551. The first connection section 551 and the second connection section 542 include, for example, a spline, a serration, or a key and a key groove. Thus, inputter 55 is fixed to the input shaft 54 so as not to rotate around at least the axis 541. In the present embodiment, the inputter 55 and the input shaft 54 are separated components (individual members) but may be integral with each other.

The outputter 56 is a member for transmitting the rotative power received from the inputter 55 to the drive sprocket 57. The outputter 56 and the input shaft 54 are coaxisally disposed. The output shaft 74 is supported rotatably about the axis 541, coaxially with the inputter 55, by a bearing 652 and a bearing 651. The bearing 652 is attached to an outer peripheral surface of the inputter 55. The bearing 651 is attached to the second split body 53 to be concentric with the second through hole 532. The outputter 56 includes an outputter 561 and a teeth part 562. In the present embodiment, the outputter 561 and the teeth part 562 are integral with each other.

The outputter 561 is a portion to which the drive sprocket 57 is to be attached. When the drive sprocket 57 is attached to the outputter 561, the drive sprocket 57 is fixed to the outputter 561. The outputter 561 is formed at an outer-side (here, right-side) end of the outputter 56 in the rightward/leftward directions and protrudes from the unit case 51.

The teeth part 562 is connected to the deceleration mechanism 59. Specifically, the teeth part 562 engages a gear (a second transmission gear 62) of the deceleration mechanism 59. Thus, power input from the deceleration mechanism 59 to the outputter 561 is transmitted to the drive sprocket 57.

Between the inputter 55 and the outputter 56, a one-way clutch 581 is provided. Here, one rotation direction about the axis 541 when the electric bicycle 1 is accelerated in the front direction is defined as an acceleration direction. On the other hand, one rotation direction about the axis 541 when the electric bicycle 1 is decelerated in the front direction is referred to as a deceleration direction.

When the inputter 55 rotates with respect to the outputter 56 in the acceleration direction, the one-way clutch 581 rotates the outputter 56 in the acceleration direction about the axis 541 at the same angular velocity as the inputter 55. On the other hand, when the inputter 55 rotates with respect to the outputter 56 in the deceleration direction, the one-way clutch 581 interrupts transmission of the rotative power from the inputter 55 to the outputter 56. Thus, when power input from the deceleration mechanism 59 to the outputter 56 rotates the outputter 56 with respect to the inputter 55 in the acceleration direction, that is, when the inputter 55 rotates with respect to the outputter 56 in the deceleration direction, the one-way clutch 581 interrupts transmission of the rotative power from the outputter 56 to the inputter 55.

When rotative power in the acceleration direction is applied from the crank arms 90 to the input shaft 54, the input shaft 54 rotates in the acceleration direction about the axis 541, and as the input shaft 54 rotates, the inputter 55 rotates in the acceleration direction. When the inputter 55 rotates in the acceleration direction about the axis 541, rotative power of the inputter is transmitted via the one-way clutch 581 to the outputter 56. Then, the inputter 55 rotates the outputter 56 in the acceleration direction about the axis 541 and rotates the drive sprocket 57 in the acceleration direction about the axis 541. At this time, the drive sprocket 57 rotates the rear sprocket 422 via the power transmitter 92, thereby rotating the rear wheel 42. Thus, the electric bicycle 1 travels in the front direction.

The motor 7 receives driving electric power and outputs rotative power. As used herein, the “driving electric power” means electric power for driving the motor 7. The driving electric power is electric power supplied from a controller formed on the substrate 8. The controller is connected to the battery device 3. The motor 7 includes a metal cup 71, a stator 72, a rotor 73, and an output shaft 74.

The metal cup 71 accommodates the stator 72 and the rotor 73. The metal cup 71 has a bottomed cylindrical shape having an opening surface facing in one direction (here, the right direction) and is to be attached to the first split body 52. When the metal cup 71 is attached to the first split body 52, the opening surface of the metal cup 71 faces the outer surface of the first side wall 521.

The stator 72 is attached to an inner side of the metal cup 71 and is fixed to the metal cup 71. In the present embodiment, the stator 72 has a cylindrical shape and is fit in an inner peripheral surface of the metal cup 71. The rotor 73 is disposed on an inner side of the stator 72 and is rotatable with respect to the stator 72. The output shaft 74 is attached to the rotor 73.

The output shaft 74 outputs the rotative power of the motor 7. The output shaft 74 is fixed to the rotor 73. When the metal cup 71 is attached to the first split body 52, an opposite end of the output shaft 74 from the rotor 73 in the longitudinal direction is inserted in the unit case 51 via the motor through hole 523 (see FIG. 4). The output shaft 74 is supported by a bearing 653 and a bearing 654 rotatably about an axis 741 extending in the rightward/leftward directions. The bearing 653 is attached to the metal cup 71. The bearing 654 is attached to the second split body 53. The output shaft 74 has a portion which is to inserted in the unit case 51 and which has a teeth part 742 connected to the deceleration mechanism 59.

The deceleration mechanism 59 receives the rotative power from the output shaft 74 of the motor 7 and transmits the rotative power to the outputter 56 such that the rotation speed of the outputter 56 is slower than the rotation speed of the output shaft 74. In the present embodiment, the deceleration mechanism 59 includes a transmission rotary shaft 60, a first transmission gear 61, and a second transmission gear 62.

The transmission rotary shaft 60 is rotatable about an axis 601 extending in the rightward/leftward directions. The transmission rotary shaft 60 is supported by a bearing 655 attached to the first split body 52 and a bearing 656 attached to the second split body 53. The first transmission gear 61 and the second transmission gear 62 are coaxially attached to the transmission rotary shaft 60.

The bearing 654 supporting the output shaft 74 is disposed to at least partially overlap the bearing 656 supporting the transmission rotary shaft 60 when viewed in a direction which is substantially orthogonal to the output shaft 74 and in which the transmission rotary shaft 60 and the output shaft 74 are aligned. Here, the bearing 654 supporting an opposite end of the output shaft 74 from the rotor 73 in a longitudinal direction of the output shaft 74 is desirably disposed to be farther away from the rotor 73 than the second transmission gear 62 is in the longitudinal direction of the output shaft 74. With this configuration, a long distance is secured between the bearing 653 and the bearing 654 of the output shaft 74, and rotation of the output shaft 74 is thus stabilized. This improves tooth contact between the teeth part 742 of the output shaft 74 and the first transmission gear 61, thereby improving the durability of the motor unit 5.

The first transmission gear 61 engages the teeth part 742 of the output shaft 74 of the motor 7. The first transmission gear 61 receives the rotative power of the output shaft 74 rotating about the axis 741 and may rotate about the axis 601. Between the first transmission gear 61 and the transmission rotary shaft 60, a one-way clutch 582 is disposed. When the first transmission gear 61 rotates about the axis 601 in the acceleration direction with respect to the transmission rotary shaft 60, the one-way clutch 582 rotates the transmission rotary shaft 60 in the acceleration direction about the axis 601 at the same angular velocity as the first transmission gear 61. On the other hand, when the first transmission gear 61 rotates in the deceleration direction about the axis 601 with respect to the transmission rotary shaft 60, the one-way clutch 582 interrupts transmission of the rotative power between the first transmission gear 61 and the transmission rotary shaft 60. Thus, for example, while the transmission rotary shaft 60 rotates in the acceleration direction about the axis 601, the rotation of the output shaft 74 of the motor 7 about the axis 741 may stop, and in this case, the first transmission gear 61 rotates in the deceleration direction about the axis 601 with respect to the transmission rotary shaft 60. In this case, the one-way clutch 582 interrupts the transmission of the power between the transmission rotary shaft 60 and the first transmission gear 61.

The second transmission gear 62 engages the teeth part 562 of the outputter 56. The second transmission gear 62 is fixed to the transmission rotary shaft 60 and rotates about the axis 601 at the same angular velocity as the rotation of the transmission rotary shaft 60 about the axis 601. In the present embodiment, the second transmission gear 62 is a component (individual member) separated from the transmission rotary shaft 60, but the second transmission gear 62 and the transmission rotary shaft 60 may be integral with each other.

When the output shaft 74 of the motor 7 rotates in the acceleration direction about the axis 741, the first transmission gear 61 rotates in the acceleration direction about the axis 601. The rotative power of the first transmission gear 61 in the acceleration direction about the axis 601 is transmitted via the one-way clutch 582 to the transmission rotary shaft 60 and rotates the outputter 56 in the acceleration direction. Moreover, as described above, power obtained from the pedal force input from the crank arms 90 is also transmitted to the outputter 56. Thus, in the outputter 56, force resulting from the pedal force and the drive assist output from the motor 7 are combined with each other. In sum, the motor unit 5 according to the present embodiment is a so-called one-shaft motor unit 5.

Moreover, while the electric bicycle 1 travels in the front direction, the output from the motor 7 may stop, and in this case, the first transmission gear 61 rotates in the deceleration direction about the axis 601 with respect to the transmission rotary shaft 60. This interrupts the transmission of the power between the transmission rotary shaft 60 and the first transmission gear 61. For example, also when driving of the motor 7 is stopped, for example, when driving electric power supplied to the motor 7 is stopped, rotative power in the deceleration direction is suppressed from being applied to the drive sprocket 57, and in addition, the crank arms 90 are suppressed from being receiving an excessive load.

As illustrated in FIG. 3, the motor unit 5 according to the present embodiment further includes a torque detector 63, a rotation speed detector 64, and the substrate 8 having a controller. The torque detector 63, the rotation speed detector 64, and the substrate 8 are accommodated in the unit case 51.

When receiving the pedal force, the torque detector 63 detects torque generated at the input shaft 54. In the present embodiment, the torque detector 63 is a magnetostrictive torque sensor. However, in the present disclosure, the torque detector 63 is not limited to the magnetostrictive torque sensor but may detect torque with a potentiometer.

The rotation speed detector 64 detects the rotation speed of the input shaft 54 per unit time. The rotation speed detector 64 includes a sensor 641 provided to the inputter 55 and a sensing element 642 attached to the first split body 52. In the present embodiment, the rotation speed detector 64 is an optical detector, but in the present disclosure, the rotation speed detector 64 may be an electromagnetic rotation speed detector.

In the present embodiment, the substrate 8 is a printed circuit board. The substrate 8 has a controller. When the controller receives an electric signal from the torque detector 63 and an electric signal from the rotation speed detector 64, the controller controls the angular velocity of the rotor 73 based on the electric signals. The controller includes, for example, a microcomputer as a main component and executes a program stored in storage such as Read Only Memory (ROM), thereby controlling operation of each element.

In the present embodiment, the substrate 8 is disposed along the first side wall 521 of the first split body 52. That is, the substrate 8 is disposed along an inner surface of the unit case 51. The substrate 8 overlaps at least part of the motor 7 when viewed in the longitudinal direction (here the rightward/leftward directions) of the output shaft 74 of the motor 7. In the present embodiment, the thickness direction of the substrate 8 is parallel to the longitudinal direction of the output shaft 74. The substrate 8 has the first surface 81 and the second surface 82 aligned in the thickness direction of the substrate 8.

The first surface 81 is a surface which is one of a pair of principal surfaces of the substrate 8 and which faces away from the motor 7 (here, faces the right side). In the present embodiment, the first surface 81 is a mounting surface of an electric component 811. On the first surface 81, a plurality of electric components 811 are mounted. In the present disclosure, “mounted on the first surface 81” means that mounting components such as the electric components 811 are arranged along the first surface 81 and are attached to the substrate 8. That is, “mounted on the first surface 81” includes a state where the mounting components arranged on the first surface 81 of the substrate 8 are fixed to the first surface 81 with solder, and in addition, a state where the mounting components arranged along the first surface 81 of the substrate 8 are fixed to the second surface 82 with solder.

In the present embodiment, the electric component 811 is, for example, a capacitor, an integrated circuit (hole IC), a field effect transistor (FET) 812, a diode, a coil, a resistor, or a connector. The FET 812 is a switching element for supplying electric power to the motor 7. In the present embodiment, the switching element may be a bipolar FET, a metal oxide semiconductor field effect transistor (MOSFET), or a metal semiconductor field effect transistor (MESFET).

The second surface 82 is a surface which faces an inner surface of the first side wall 521 of the first split body 52, which is one of the pair of principal surfaces of the substrate 8, and which faces the motor 7 (here, faces the left side). At least part of the second surface 82 faces a surface 700 of the motor 7. The surface 700 faces the unit case 51 (here, the surface 700 is a right-side surface). In the present embodiment, the motor 7 is located closer to the second surface 82 than to the first surface 81. That is, the distance between the motor 7 and the second surface 82 is shorter than the distance between the motor 7 and the first surface 81.

However, in the present disclosure, the distance between the motor 7 and the substrate 8 is not particularly limited. The second surface 82 of the substrate 8 may be in contact with the motor 7, or a gap may be provided between the second surface 82 and the motor 7. Moreover, in the present embodiment, the motor 7 overlaps the substrate 8 when viewed in the longitudinal direction of the output shaft 74, but in the present disclosure, the motor 7 does not have to overlap the substrate 8.

FIG. 4 is an exploded perspective view illustrating the motor 7, the first split body 52, and the substrate 8. As illustrated in FIG. 4, the motor 7 includes a projection 75 protruding from a surface 701 in contact with an outer side surface of the first split body 52 and a plurality of terminals 76 provided to the projection 75.

The projection 75 is inserted in the terminal hole 524 formed in the first split body 52. That is, the motor 7 includes the projection 75 as a portion to be inserted in the terminal hole 524. The projection 75 has a tip end surface facing the substrate 8. In the present embodiment, the tip end surface of the projection 75 is apart from the second surface 82 of the substrate 8. The plurality of terminals 76 are provided to the projection 75. Specifically, the plurality of terminals 76 protrude from the tip end surface of the projection 75 toward the substrate 8 and extends along a direction from the tip end surface to the substrate 8 of the rightward/leftward directions. The terminals 76 according to the present embodiment may be referred to as “male terminals 762”.

The substrate 8 has a plurality of (here three) through parts 83. In the present embodiment, the plurality of through parts 83 are pores in which the plurality of terminals 76 are inserted, and the plurality of through parts 83 extend from the first surface 81 through the second surface 82. In the present embodiment, the through parts 83 each have an oval shape when viewed in the rightward/leftward directions. However, in the present disclosure, the through part 83 may be elliptic, quadrangular, circular, or polygonal. Moreover, in the present disclosure, the through part 83 may be one pore obtained by connecting the plurality of pores in the present embodiment or may be a cut-out obtained by cutting out an external edge portion from the substrate 8.

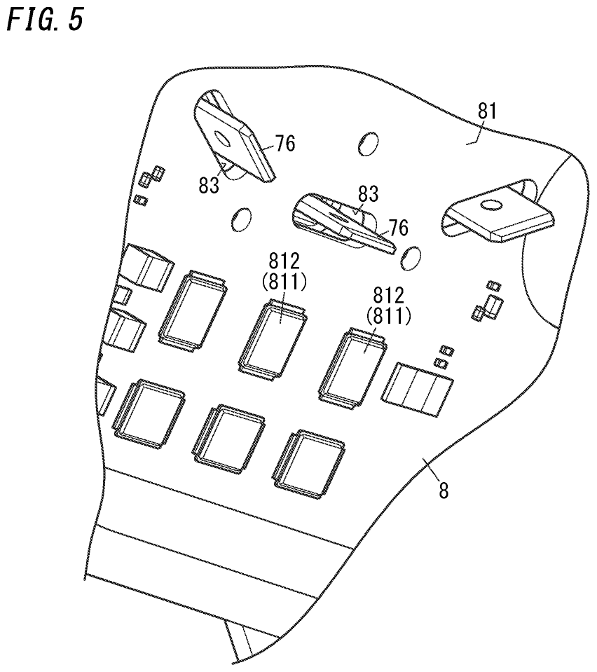

Positioning of the substrate 8 is performed with the first peripheral wall 525 of the first split body 52, and in this state, the substrate 8 is attached to the first split body 52 via a fixation member such as a screw. When the substrate 8 is attached to a prescribed fixed position of the first side wall 521 of the first split body 52, and the motor 7 is attached to an outer surface of the first side wall 521 of the first split body 52, the terminals 76 are inserted into the through parts 83 and protrude from the first surface 81 of the substrate 8 as illustrated in FIG. 5. In the present embodiment, the plurality of terminals 76 are inserted into the plurality of through parts 83 on a one-to-one basis. In the present embodiment, a gap is formed between an inner peripheral surface of each through part 83 and corresponding one of the terminals 76 in a state where the terminals 76 are inserted into the respective through parts 83.

As illustrated in FIG. 6, the conductive member 84 is connected to the terminals 76 of the motor 7. The conductive member 84 is connected to the controller, and when the conductive member 84 is connected to the terminals 76 of the motor 7, the conductive member 84 serves as part of an electric path via which electric power is sent to the motor 7. In the present embodiment, the conductive member 84 is the harness 85. The harness 85 according to the present embodiment is, for example, a wire harness having a plurality of electric wires. At least one of the plurality of electric wires of the wire harness 85 is connected to the terminals 76 of the motor 7. However, in the present disclosure, the conductive member 84 does not have to be the harness 85 but may be a wire, a spring body 86 (see a second variation), or the like.

The harness 85 includes an electrical wire 851 including a conductor and a connector 853 provided to a tip end of the electrical wire 851. An end in a longitudinal direction of the electrical wire 851 is mounted on the first surface 81 of the substrate 8.

The electrical wire 851 is deformable over its entire length, and in the present embodiment, the electrical wire 851 is flexible over its entire length. However, in the present disclosure, at least part of the electrical wire 851 in the longitudinal direction is deformable, and the electrical wire 851 does not have to be deformable over its entire length. The electrical wire 851 includes a connector 852. The connector 852 is formed at an end of the electrical wire 851 and is connected to a circuit of the substrate 8. In the present embodiment, the connector 852 is connected to the circuit formed on the second surface 82 of the substrate 8 with solder. In the longitudinal direction of the electrical wire 851, a connector 853 is provided at an opposite end of the electrical wire 851 from the connector 852.

The connector 853 is part of the conductive member 84 and is to be connected to the terminal 76 of the motor 7. In the present embodiment, the connector 853 is a female connector 855. When the connector 853 is connected to the terminal 76, the tip end surface of the connector 853 faces the first surface 81. In the present embodiment, the tip end surface of the connector 853 is apart from the first surface 81, but in the present disclosure, the tip end surface may be in contact with the first surface 81. In sum, the connector 853 is located closer to the first surface 81 than to the second surface 82 in the thickness direction of the substrate 8.

Thus, in the motor unit 5 according to the present embodiment, the terminal 76 is not fixed to the substrate 8 with solder or the like, and therefore, even when the motor unit 5 vibrates, stress caused at the substrate 8 due to force applied by the terminal 76 is reduced.

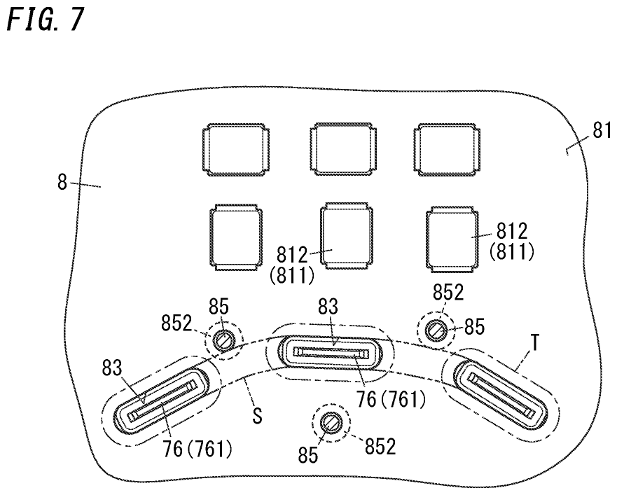

FIG. 7 is an enlarged view illustrating portion B of FIG. 2. A plurality of (here, six) FETs 812 as the electric components 811 are mounted on the substrate 8. The FETs 812 are connected to the circuit formed on the substrate 8 and to the terminals 76 via the harnesses 85 mounted on the first surface 81 of the substrate 8. In the present embodiment, two of the connectors 852 of the plurality of harnesses 85 are located between the through part 83 and the FET 812 (switching element) when viewed in the thickness direction of the substrate 8 as illustrated in FIG. 7.

Here, in the present disclosure, saying that the connector 852 is “located between the through part 83 and the switching element” means that when the plurality of through parts 83 are formed, the connector 852 is located between a virtual line S connecting the plurality of through parts 83 and the switching element (here, FET 812). That is, saying that the connector 852 is “located between the through part 83 and the switching element” includes a case where the connector 852 is located between the switching element and an area between adjacent through parts 83. In the present disclosure, the connector 852 may be located on the virtual line S, and at least part of the connector 852 is located between the virtual line S and the switching element. In the present embodiment, the two of the connectors 852 are located between the through part 83 and the FET 812 when viewed in the thickness direction of the substrate 8. In the present disclosure, one of the plurality of connectors 852 may be located between the through part 83 and the FET 812, and the other connectors 852 may be located at places other than the location between the through part 83 and the FET 812. Since at least one connector 852 is located between the through part 83 and the switching element when viewed in the thickness direction of the substrate 8, a wide area of a circuit connecting the connector 852 to the switching element is secured.

Moreover, in the present embodiment, an outer side portion of the through part 83 has an electrically insulating property. In the present disclosure, the “outer side portion of the through part 83” means part of the first surface 81 of the substrate 8, the part being located at a peripheral edge of the through part 83. In the present embodiment, a land is formed neither on the outer side of the through part 83 on the first surface 81 nor on an inner peripheral surface of the through part. In the present embodiment, as illustrated in FIG. 7, no land is formed in at least a portion T surrounded by the long dashed short dashed line. That is, the outer side portion of the through part 83 is electrically insulated from the other portions over the entire length in the circumferential direction of the through part 83.

Thus, according to the motor unit 5 of the present embodiment, electrical influence over the motor 7 and the like is reduced even when the terminal 76 vibrates and the terminal 76 comes close to the peripheral edge of the through part 83.

(2) Variations

The embodiment is one of the various embodiments of the present disclosure. Various modifications may be made to the embodiment depending on design and the like as long as the object of the present disclosure is achieved. Note that any of the variations to be described below may be combined as appropriate.

(2.1) First Variation

In the above-described embodiment, each terminal 76 is the male terminal 762. However, in the present variation, terminals 76 of a motor 7 are each a female terminal 761, and in this regard, the present variation is different from the embodiment.

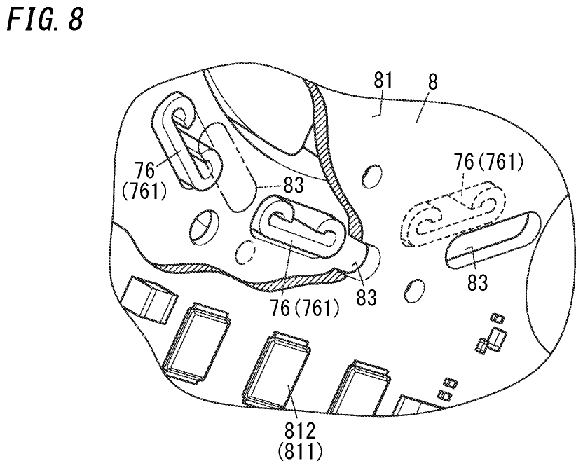

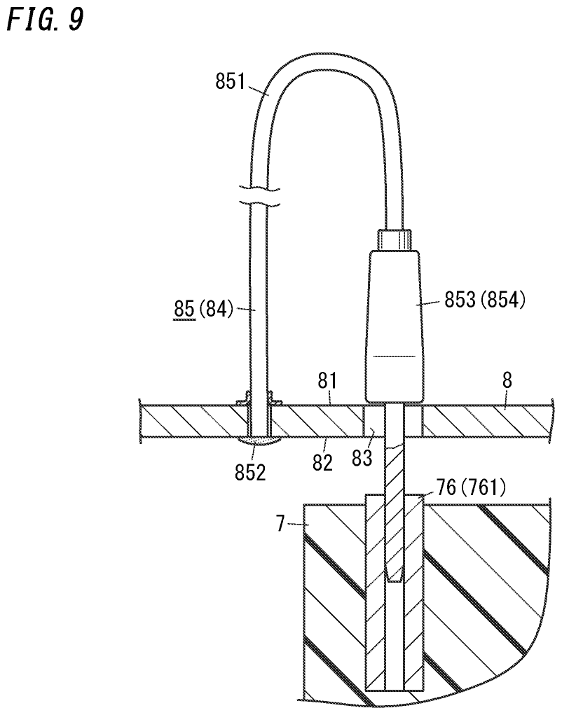

As illustrated in FIG. 8, a tip end surface of each terminal 76 according to the present variation is located closer to a second surface 82 than to a first surface 81 in a thickness direction of a substrate 8. In other words, the tip end surface of each terminal 76 is located between the second surface 82 and a motor in the thickness direction of the substrate 8. The terminals 76 of the motor 7 are located to correspond to respective through parts 83. In the present variation, each terminal 76 of the motor 7 is configured such that a connector 853 of a conductive member 84 is to be inserted in the terminal 76 as illustrated in FIG. 9.

The conductive member 84 is a harness 85 in a similar manner to the above-described embodiment. In the present variation, the conductive member 84 includes an electrical wire 851 having flexibility and the connector 853 connected to a tip end of the electrical wire 851. The connector 853 is a male connector 854. The connector 853 is inserted through the through part 83 and is inserted into and is connected to the female terminal 761 of the motor 7.

(2.2) Second Variation

In the above-described embodiment, the conductive member 84 is the harness 85, but in the present variation, a conductive member 84 is a spring body 86, and in this regard, the present variation is different from the embodiment.

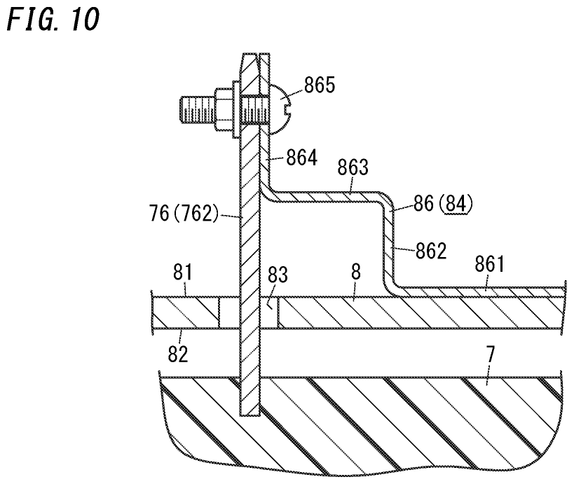

As illustrated in FIG. 10, the spring body 86 is attached to a first surface 81 of a substrate 8, that is, is mounted on the first surface 81 of the substrate 8. The spring body 86 is conductive and electrically connects a circuit on the substrate 8 to a terminal 76. The spring body 86 is elastic and is elastically deformable. The spring body 86 includes a first piece 861, a second piece 862, a third piece 863, and a connection piece 864. In the present variation, the first piece 861, the second piece 862, the third piece 863, and the connection piece 864 are integrally formed from an elastic conductor.

The first piece 861 is connected to the circuit. At least part of the first piece 861 is a connector connected to the circuit. The second piece 862 is continuous to the first piece 861 and extends in a direction away from the first surface 81. The third piece 863 is continuous to an end of the second piece 862 and extends in a direction along the first surface 81. The connection piece 864 is continuous to the third piece 863 and extends along the terminal 76 (a male terminal 762). The connection piece 864 is fixed to the terminal 76 with a fixation member 865.

Thus, also in the present variation, the terminal 76 and a through part 83 are not fixed to each other. Thus, even when a motor unit 5 vibrates, stress caused at the substrate 8 due to force applied by the terminal 76 is reduced.

(2.3) Third Variation

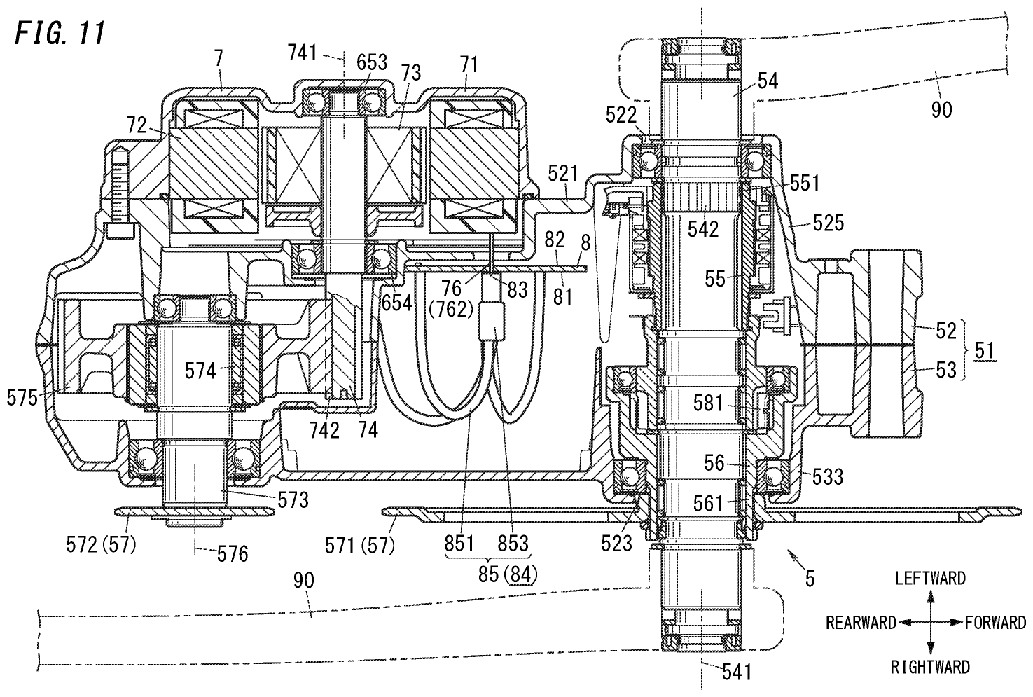

In the above-described embodiment, a so-called one-shaft motor unit 5 has been described, but as illustrated in FIG. 11, a two-shaft motor unit 5 may be used.

The motor unit 5 according to the present variation includes an electric-powered rotary shaft 573 other than an input shaft 54. The electric-powered rotary shaft 573 outputs a drive assist output from an output shaft 74 of a motor 7. The electric-powered rotary shaft 573 is rotatable about an axis 576 extending in the rightward/leftward directions. A second drive sprocket 572 as a drive sprocket 57 is attached to one end (here, a right-side end) in a longitudinal direction of the electric-powered rotary shaft 573. The second drive sprocket 572 is fixed to the electric-powered rotary shaft 573. A gear 575 is attached to the other end (here, a left-side end) of the electric-powered rotary shaft 573. The gear 575 engages a teeth part 742 formed on the output shaft 74 of the motor 7. Between the electric-powered rotary shaft 573 and the gear 575, a one-way clutch 574 is disposed.

When the gear 575 rotates in the acceleration direction with respect to the electric-powered rotary shaft 573, the one-way clutch 574 transmits power to the electric-powered rotary shaft 573. On the other hand, when the gear 575 rotates in the deceleration direction with respect to the electric-powered rotary shaft 573, the one-way clutch 574 interrupts transmission of power between the gear 575 and the electric-powered rotary shaft 573.

In the present variation, a power transmitter 92 (see FIG. 1) is hung on a first drive sprocket 571 as the drive sprocket 57 attached to the input shaft 54, a second drive sprocket 572, and a rear sprocket 422 (see FIG. 1).

In the present variation, in an electric bicycle 1, when pedal force is input from crank arms 90 and the output shaft 74 of the motor 7 rotates in the acceleration direction, the gear 575 rotates in the acceleration direction. Rotative power of the gear 575 about the axis 576 is transmitted via the one-way clutch 574 to the electric-powered rotary shaft 573, thereby rotating the second drive sprocket 572.

The motor unit 5 according to the present variation has a substrate 8 disposed between the electric-powered rotary shaft 573 and the input shaft 54. A terminal 76 of the motor 7 is a male terminal 762 and protrudes from a first surface 81 of the substrate 8. A harness 85 as a conductive member 84 is connected to the terminal 76.

(2.4) Fourth Variation

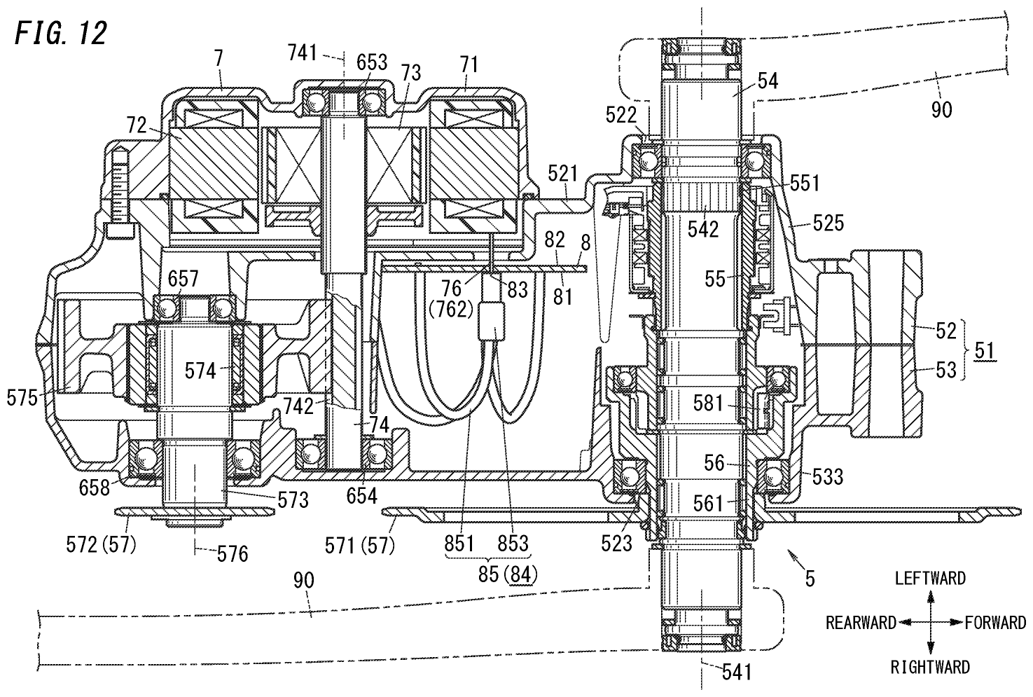

The two-shaft motor unit according to the third variation may have a configuration as illustrated in FIG. 12. The present variation is in large part the same as the third variation, and therefore, differences from the third variation will mainly be described.

An electric-powered rotary shaft 573 is attached rotatably about an axis 576 via a bearing 657 and a bearing 658. The bearing 657 is attached to an inner surface of a first split body 52. The bearing 658 is attached to an inner surface of a second split body 53.

An output shaft 74 of a motor 7 is rotatably supported by a bearing 653 and the bearing 654. The bearing 653 is attached to a metal cup 71. The bearing 654 is attached to the inner surface of the second split body 53. The bearing 654 is disposed to at least partially overlap the bearing 658 when viewed in a direction which is substantially orthogonal to the output shaft 74 and in which the electric-powered rotary shaft 573 and the output shaft 74 are aligned with each other.

Here, the bearing 654 supporting an opposite end of the output shaft 74 from the rotor 73 in a longitudinal direction of the output shaft 74 is desirably disposed to be farther away from the rotor 73 than a gear 575 is in the longitudinal direction of the output shaft 74. With this configuration, a long distance is secured between the bearing 653 and the bearing 654 of the output shaft 74, and rotation of the output shaft 74 is thus stabilized. This improves tooth contact between a teeth part 742 of the output shaft 74 and the gear 575, thereby improving the durability of the motor unit 5.

(2.5) Other Variations

Variations of the embodiment will be described below.

In the above-described embodiment, the motor 7 includes the metal cup 71, but in the present disclosure, the motor 7 may have a structure formed by resin molding of a stator 72.

In the above-described embodiment, the motor unit 5 is a motor in the electric bicycle 1, but the motor unit 5 of the present disclosure is not limited to the motor unit 5 in the electric bicycle 1.

In the embodiment, the power transmitter 92 is a chain, but in the present disclosure, the power transmitter 92 is not limited to the chain. For example, the power transmitter 92 may be a belt or a wire.

(3) Aspect

As described above, a motor unit (5) of a first aspect includes a substrate (8), a motor (7), and at least one conductive member (84). The substrate (8) has a first surface (81) and a second surface (82) in a thickness direction of the substrate (8). The motor (7) includes at least one terminal (76) and is disposed closer to the second surface (81) than to the first surface (82) in the thickness direction. The at least one conductive member (84) is mounted on the first surface (81). The substrate (8) has at least one through part (83) which extends from the first surface (81) through the second surface (82) and in which the at least one terminal (76) or the at least one conductive member (84) is inserted. The at least one conductive member (84) is at least partially deformable and is connected to the at least one terminal (76).

This aspect enables the substrate (8) to be disposed close to the motor (7), so that the motor unit (5) is downsized. Moreover, according to the motor unit (5) of the present embodiment, the substrate (8) is disposed close to the motor (7), but the substrate (8) is not fixed to the at least one terminal (76) of the motor (7) with solder, and the at least one terminal (76) is not bound to the substrate (8). Thus, even when the substrate (8) and the motor (7) vibrate, stress caused at the substrate (8) due to force applied by the at least one terminal (76) is reduced.

In a motor unit (5) of a second aspect referring to the first aspect, the at least one conductive member (84) is a harness (85).

With this aspect, connection to the at least one terminal (76) is easily performed.

In a motor unit (5) of a third aspect referring to the first or second aspect, the at least one terminal (76) protrudes from the first surface (81). The at least one conductive member (84) has a portion which is connected to the at least one terminal (76) and which is located closer to the first surface (81) than to the second surface (82).

With this aspect, also when a motor (7) having a male terminal (76) is used, fixing of the terminal (76) to the substrate (8) is avoided.

In a motor unit (5) of a fourth aspect referring to the third aspect, the at least one conductive member (84) is at least partially elastic. The at least one conductive member (84) is fixed to the at least one terminal (76) via a fixation member (865).

With this aspect, the motor (7) is connectable to a circuit of the substrate (8) via a material which is relatively hard to deform as compared to the harness (85), and damage caused due to vibration of the at least one conductive member (84) is reduced as much as possible.

In a motor unit (5) of a fifth aspect referring to the first or second aspect, the at least one terminal (76) is located closer to the second surface (82) than to the first surface (81). The at least one conductive member (84) is connected to the at least one terminal (76) in a state where the conductive member (84) is inserted in the through part (83).

With this aspect, also when a motor (7) having a male terminal (76) is used, fixing of the terminal (76) to the substrate (8) is avoided.

In a motor unit (5) of a sixth aspect referring to any one of the first to fifth aspects, the first surface (81) has a part which is located on an outer side of the through part (83) and which has an electrically insulating property.

With this aspect, electrical influence over the motor (7) and the like is reduced even when the at least one terminal (76) vibrate and the at least one terminal (76) comes close to the peripheral edge of the through part (83).

A motor unit (5) of a seventh aspect referring to any one of the first to sixth aspects further includes a switching element (in the embodiment, the FET (812)) mounted on the substrate (8). The motor unit (5) includes a plurality of conductive members (84). Each of the plurality of conductive members (84) has a connector (852) connected to the switching element via a circuit. The connector of at least one connector (852) of the plurality of connectors (852) of the plurality of conductive members (84) is located between the through part (83) and the switching element when viewed in the thickness direction of the substrate (8).

With this aspect, since at least one connector (852) is located between the through part (83) and the switching element when viewed in the thickness direction of the substrate (8), a wide area of the circuit connecting the connector (852) to the switching element is secured.

An electric bicycle (1) of an eighth aspect includes a frame (2), the motor unit (5) of any one of the first to seventh aspects, the motor unit (5) being attached to the frame (2), and a wheel (4). The wheel (4) is attached to the frame (2) and is configured to be rotated by power output from the motor unit (5).

This aspect provides the electric bicycle (1) configured to reduce stress caused by force which the terminal (76) of the motor (7) applies to the substrate (8) due to vibration.

A motor unit (5) of a ninth aspect referring to any one of the first to seventh aspects further includes the first surface (81) is a mounting surface of an electric component (811). The second surface (82) is provided with a circuit.

With this aspect, the electric component (811) mounted on the first surface (81) is not located between the substrate (8) and the motor (7), and therefore, the motor 7 and the substrate (8) are disposed to be much closer to each other.

A motor unit (5) of a tenth aspect referring to any one of the first to seventh aspects and the ninth aspect further includes a unit case (51) which accommodates the substrate (8). The substrate (8) is disposed along an inner surface of the unit case (51). The motor (7) is disposed along an outer surface of the unit case (51). The unit case (51) has a terminal hole 524. The motor (7) has a portion (in the embodiment, the projection (75)) which is to inserted into the terminal hole 524. The portion is provided with the terminal (76).

This aspect enables the motor (7) to be disposed close to the substrate (8) accommodated in the unit case (51).

The configurations of the second to seventh aspects are not essential configurations of the motor unit (5) and the electric bicycle (1) and may be omitted accordingly. Moreover, the configurations according to the ninth and tenth aspects are not essential configurations of the motor unit (5) and the electric bicycle (1) and may be omitted accordingly. Moreover, the electric bicycle (1) according to the eighth aspect may include the motor unit (5) of the ninth or tenth aspect in place of the motor unit (5) of any one of the first to seventh aspects.

### REFERENCE SIGNS LIST

1 ELECTRIC BICYCLE

4 WHEEL

5 MOTOR UNIT

76 TERMINAL

8 SUBSTRATE

81 FIRST SURFACE

812 FET (SWITCHING ELEMENT)

82 SECOND SURFACE

83 THROUGH PART

84 CONDUCTIVE MEMBER

85 HARNESS

852 CONNECTOR

865 FIXATION MEMBER

1. A motor unit, comprising:
a substrate having a first surface and a second surface in a thickness direction of the substrate;
a motor including at least one terminal and disposed closer to the second surface than to the first surface in the thickness direction; and
at least one conductive member mounted on the first surface,
the substrate having at least one through part which extends from the first surface through the second surface and in which the at least one terminal or the at least one conductive member is inserted,
the at least one conductive member being at least partially deformable and being connected to the at least one terminal.

2. The motor unit of claim 1, wherein
the at least one conductive member is a harness.

3. The motor unit of claim 1, wherein
the at least one terminal protrudes from the first surface, and
the at least one conductive member has a portion which is connected to the at least one terminal and which is located closer to the first surface than to the second surface.

4. The motor unit of claim 3, wherein
the at least one conductive member is at least partially elastic, and
the at least one conductive member is fixed to the at least one terminal via a fixation member.

5. The motor unit of claim 1, wherein
the at least one terminal is located closer to the second surface than to the first surface, and
the at least one conductive member is connected to the at least one terminal in a state where the at least one conductive member is inserted in the through part.

6. The motor unit of claim 1, wherein
the first surface has a part which is located on an outer side of the through part and which has an electrically insulating property.

7. The motor unit of claim 1, further comprising:
a switching element mounted on the substrate, wherein
the at least one conductive member includes a plurality of conductive members,
each of the plurality of conductive members has a connector connected to the switching element via a circuit, and
the connector of at least one of the plurality of conductive members is located between the through part and the switching element when viewed in the thickness direction.

8. An electric bicycle, comprising:
a frame;
the motor unit of claim 1, the motor unit being attached to the frame; and
a wheel attached to the frame and configured to be rotated by power output from the motor unit.
